(19) United States
(12) Patent Application Publication
(10) Pub. No.: US 2005/0282520 A1
(43) Pub. Date: Dec. 22, 2005

(54) System and method for managing access to a protected digital content transmitted to a mobile terminal

(76) Inventor: Laurent Coureau, Morangis (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/513,712

(22) PCT Filed: May 12, 2003
(86) PCT No.: PCT/FR03/01452

§ 371 Date: Jul. 7, 2005

(30) Foreign Application Priority Data
May 13, 2002 (FR) 02/05859

(51) Int. Cl. H04M 3/16

(52) U.S. Cl. 455/410

(57) ABSTRACT

A technique for managing access to protected digital content stored in a content broadcasting server (11) and transmitted to a mobile terminal (10) connected to a cellular mobile network (20). A copy of a right of use being stored in a right-of-use management server (12), said management system is adapted to transmit to said mobile terminal (10) a message updating said right to use the digital content without any request for a connection from said mobile terminal (10) to said right-of-use management server (12).

The present invention relates to a system and to a method for managing access to protected digital content transmitted to a mobile terminal.

The invention applies more particularly to managing the time of use of protected digital content.

Said digital content may be of different kinds, such as a digital music file, a digital video file, an e-book, a computer program, or a data processing application.

To control access to the digital content and to prevent illicit reading thereof, it may be protected by a digital data encryption method, for example.

At present, when digital content is transmitted to a receiver terminal by a content broadcast server, the right to use said digital content is either transmitted to said receiver terminal by a right-of-use management server or else it is transmitted each time said digital content is used.

The right to use a digital content controls access to said digital content, for example by indicating an authorized number of readings of said digital content or by defining an authorized time of use of said digital content.

The terminal receiving the digital content is generally equipped with an internal clock. If the time of use of the digital content is managed by the receiver terminal, the user, who may alter said internal clock, may be tempted to modify it in order to benefit from an illicit right of use.

Systems in which the time of use is managed by the receiver terminal do not prevent a “man in the middle” attack, in which a pirate user passes himself off for said right-of-use management server and sends a falsified clock authorizing illicit access to a protected content.

At present, if the time of use of the content is controlled by the right-of-use management server, a connection from the receiver terminal to the server must be set up, which delays access to the content each time it is used.

Connecting to the right-of-use management server at the time of each use of said digital content imposes a connection delay before the user can use the digital content. There is generally a charge for the connection, which increases the cost to the user of using the digital content.

Finally, for mobiles, these repeated connections to the right-of-use management server increase the traffic on the cellular network, with the risk of congestion of access to said management server.

Because of the growth of e-commerce transactions, regular and accurate control of rights of use is necessary to prevent complaints from users when billed by service providers.

At present there is a need to make management of the time of access to protected digital content more reliable than is possible using the internal clock of the receiver terminal.

Thus the technical problem to be solved by the present invention is that of proposing a system and a method for managing access to protected digital content stored in a content broadcasting server and transmitted to a mobile terminal connected to a cellular mobile network that remedy the drawbacks of the existing systems by avoiding, at the time of use of said digital content, connection of the user to a right-of-use management server to manage the time of use of said digital content.

According to the present invention, the solution to the stated technical problem consists in that, a right of use being transmitted to said mobile terminal by a right-of-use management server, said management system is adapted to store a copy of said right of use in said right-of-use management server and to transmit to said mobile terminal a message updating said right to use the digital content.

In the same way, the method for managing access to protected digital content stored in a content broadcasting server and transmitted to a mobile terminal connected to a cellular mobile network is noteworthy in that it includes the steps of transmitting said digital content from said content broadcasting server to said mobile terminal, transmitting a right of use associated with said transmitted digital content from a right-of-use management server to said mobile terminal, storing a copy of said transmitted right of use in a database, storing the validity time of said right of use associated with the digital content transmitted, and transmitting from said right-of-use management server to said mobile terminal a message updating said right to use the digital content with no request for connection from said mobile terminal.

Accordingly, the system and the method of the invention for managing access to protected digital content from a mobile terminal provide synchronized management of the time of use of said digital content at a single point in said right-of-use management server.

According to the invention, said message updating said right of use is transmitted to said right-of-use management server with no connection request from said mobile terminal.

According to the invention, said message updating said right of use is transmitted to said mobile terminal by an electronic message management center of said cellular mobile network.

According to the invention, said message updating said right of use is a control message transmitted without intervention by the user of said mobile terminal.

Said electronic message management center sets up a connection to said mobile terminal to transmit said message updating said right of use.

Said message updating said right of use is a control message that is transparent for the user and gives rise to no billing of the user. The user need take no action and cannot intervene in the execution of said message.

The following description with reference to the appended drawing is provided by way of non-limiting example and explains in what the invention consists and how it may be put into practice, and other features of the invention emerge therefrom.

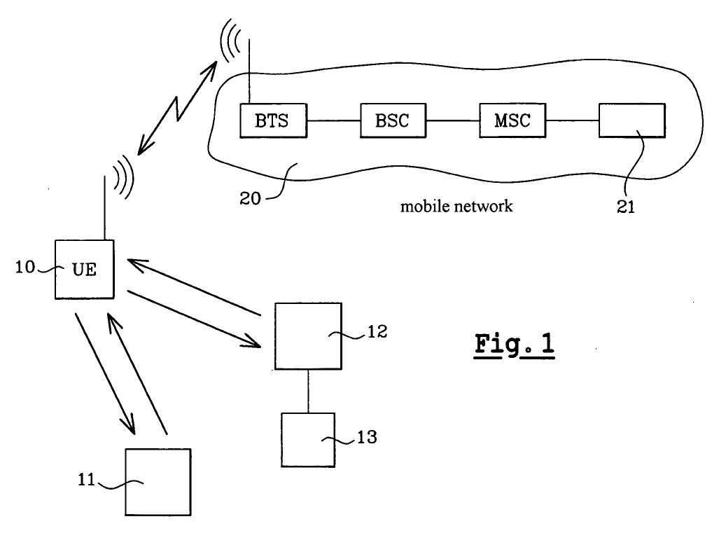

FIG. 1 is a diagram of the general architecture of a system of the invention for managing access to protected digital content.

To simplify the description, in this diagram a mobile terminal 10 constitutes the subscriber to the mobile telecommunications network, but the subscriber may be of some other kind, for example a server or a mobile communications terminal, a personal computer (PC), or a television set, and in FIG. 1 is represented as a user equipment (UE) 10.

Whatever kind of terminal 10 is used, it is connected to a public mobile network to which the user is a subscriber.

The invention applies to all communications networks using identical techniques to transmit control messages to a mobile terminal.

The mobile terminal 10 is connected to any type of cellular mobile communications network allowing the transmission of control messages to a mobile terminal, for example a Global System for Mobile communications (GSM) network, a General Packet Radio Service (GPRS) network, or a Universal Mobile Telecommunication System (UMTS) network.

To simplify the description, the cellular network is described using GSM terminology.

The user in possession of a mobile terminal 10 accesses protected digital content and the right to use said digital content for a defined time T.

Said digital content is accessible over any public or private communications network, for example the Internet.

Said digital content may be of various kinds, such as a digital music file, a digital video file, an e-book, a computer program or a data processing application.

The content broadcast server 11 transmits the protected digital content to the terminal 10 of the person requesting access.

The digital content may be protected by any kind of encryption method compatible with the application installed on the mobile terminal 10 of the person requesting access, who is a subscriber to the content provision service.

The right-of-use management server 12 transmits to the terminal 10 the right of use associated with the transmitted digital content, which includes a defined time of use.

The content broadcast server 11 and the right-of-use management server 12 may or may not be located on the same server, depending on the network hardware.

The right-of-use management server 12 stores a copy of the right of use transmitted to the mobile terminal 10 and the precise time (date, hour, second, etc.) at which said right of use begins and from which the digital content is usable by the terminal 10, for example in a database 13.

In particular, the management server 12 stores the validity time T during which the digital content may be consulted on the mobile terminal 10.

The database 13 may or may not be physically included in the right-of-use management server 12.

The user is then able to make free use of the digital content for the time T, as a function of other rights of use, for example an authorized number of readings of the digital content.

At the end of the time T, the right-of-use management server 12 transmits at least one right of use update message indicating the expiry of the predetermined time.

If necessary, a message may also be transmitted in advance, for example to inform the user that the time of use has nearly expired.

Said right of use update message passes through an electronic message management center 21 of the mobile network 20.

For example, said right of use update message, coming from the right-of-use management server 12, is transmitted by the Short Message Service (SMS), the Multimedia Message Service (MMS), or the Extended Message Service (EMS), or by any other type of message service supported by the mobile network 20.

For example, said electronic message management center 21 is a Short Message Service Center (SMSC) or a Multimedia Message Service Center (MMSC) or any other electronic message management center, depending on the type of mobile network.

In the same way as for any other message, the mobile network 20 transmits said right of use update message to the mobile terminal 10 via a mobile switching center (MSC) of the mobile network, a base station controller (BSC), and finally a base transceiver station (BTS).

Said right of use update message is of the “control message” type for the mobile terminal 10.

For example, using the Short Message Service, said control message is a Short Message Service—Over The Air (SMS-OTA) message that the mobile network 20 uses for signaling.

Said control message is transmitted from said electronic message management center 21 to said mobile terminal 10 without intervention by the user of said mobile terminal 10. Consequently, it is not billed to the user of said mobile terminal 10.

This is because the mobile terminal 10 does not intentionally set up a connection to receive said update message. Because of this, the message is transparent for the user of the mobile terminal 10, who need do nothing and is not able to intervene in the execution of said right of use update message.

Because of the nature of the control message that is transmitted, said right of use update message is characterized by the fact that the user cannot refuse to receive it on the mobile terminal 10.

Depending on circumstances, after reception of said right of use update message, said right of use is either updated with a zero period of use or deleted in the terminal 10. The digital content is then unusable on the terminal 10.

1. A system for managing access to protected digital content stored in a content broadcasting server (11) and transmitted to a mobile terminal (10) connected to a cellular mobile network (20), the system comprising, a right-of-use management server (12) for storing a right of use, said management system is adapted to transmit to said mobile terminal (10) a message updating said right to use the digital content without any request for a connection from said mobile terminal (10) to said right-of-use management server (12).

2. A system according to claim 1 for managing access to protected content, wherein said message updating said right of use is a control message transmitted without intervention by the user of said mobile terminal (10).

3. A system according to claim 1 for managing access to protected digital content, wherein said message updating said right of use indicates the end of validity of said right to use the digital content.

4. A system according to claim 1 for managing access to protected digital content, characterized in that said message updating said right of use is transmitted to said mobile terminal (10) by an electronic message management center of said cellular mobile network (20).

5. A server (12) for managing rights of use associated with a system for managing access to protected digital content according to claim 1, characterized in that it comprises means for transmitting to a mobile terminal (10), means for transmitting to an electronic message management center (21) of said cellular mobile network (20), means for storing a right to use a digital content, and means of sending a message updating said right to use a digital content with no request for connection of said mobile terminal (10).

6. A server (12) according to claim 5 for managing rights of use associated with a system for managing access to protected digital content, characterized in that said storage means of said right-of-use management server (12) comprise a database (13).

7. A method for managing access to protected digital content stored in a content broadcasting server (11) and transmitted to a mobile terminal (10) connected to a cellular mobile network (20), wherein said method comprises the steps of:
transmitting said digital content from said content broadcasting server (11) to said mobile terminal (10),
transmitting a right of use associated with the transmitted digital content from a right-of-use management server (12) to said mobile terminal (10),
storing a copy of the transmitted right of use in a database (13),
storing the validity time of said right of use associated with the transmitted digital content, and
transmitting from said right-of-use management server (12) to said mobile terminal (10) a message updating said right to use the digital content with no request for connection from said mobile terminal (10).
